(19) United States
(12) Patent Application Publication
(10) Pub. No.: US 2013/0268632 A1
(43) Pub. Date: Oct. 10, 2013

(54) SERVER ASSISTED AUTHENTICATED DEVICE

(71) Applicant: CANON KABUSHIKI KAISHA, Tokyo (JP)

(72) Inventors: Stéphane Baron, Le Rheu (FR); Eric Majani, Saint-Gregoire (FR)

(21) Appl. No.: 13/856,255

(22) Filed: Apr. 3, 2013

Related U.S. Application Data
(60) Provisional application No. 61/620,854, filed on Apr. 5, 2012.

(51) Int. Cl. H04L 29/08

(52) U.S. Cl. CPC H04L 67/02
USPC 709/219

(57) ABSTRACT

The invention relates to an analysis server that is adapted to guide a client device to log in to a wide area network like the Internet. The analysis server includes a reception module configured to receive from a client device network information, the network information containing at least part of a message transmitted to the client device by an authentication server; an analysis engine configured to analyze the network information based on a set of rules; a builder module configured to build procedural information based on the result of the analysis, the procedural information containing instructions adapted to configure the client device to reply to the message sent by the authentication server; and a transmission module configured to transmit the procedural information to the client device.

### CROSS-REFERENCE

This application claims the benefit under 35 U.S.C. 119(e) of U.S. Provisional Patent Application No. 61/620,854, filed Apr. 5, 2012, which is hereby incorporated by reference in its entirety.

### BACKGROUND OF THE INVENTION

1. Field of the Invention

This invention relates to the data communication field, and more particularly to connection of devices to a communication network.

2. Description of the background art

There is an increasing demand in connecting devices to a variety of communication networks such as hotspots in coffee shops, hotels, etc. The connection procedure is however peculiar to each hotspot. Different types of requests or information may need to be provided depending on the authentication server associated to the hotspot to connect to. Also, certain sequences may also need to be followed by a client to get access granted.

### SUMMARY OF THE INVENTION

The present invention has been devised to address at least the foregoing concern. More specifically, an object of the present invention is to make the client device have access granted to the network with a variety of login procedures to follow for each type authentication server/network.

To this end, the present invention provides according to a first aspect an analysis server device comprising:
a reception module configured to receive from a client device network information, the network information containing at least part of a message transmitted to the client device by an authentication server;
an analysis engine configured to analyze the network information based on a set of rules;
a builder module configured to build procedural information based on the result of the analysis, the procedural information containing instructions adapted to configure the client device to reply to the message sent by the authentication server; and
a transmission module configured to transmit the procedural information to the client device.

According to a particular embodiment, the set of rules are centrally updated at the claimed server to adapt the configuration of the analysis engine to network information resulting from messages of various types and transmitted by one or a plurality of authentication servers.

According to another particular embodiment, network information contains information obtained from several messages transmitted by the authentication server, each message being transmitted in response to a request message sent by the client device in which a distinct application identifier has been included.

Advantageously, chances are increased to get a message from the authentication server for which rules exist at the server device or that the probability to authenticate successfully is greater when the client uses certain application than others, information which is provided by the rules.

According to a further particular embodiment, the received network information is compressed and segmented in a plurality of packets, each packet being formatted as a DNS packet. Such DNS packets can go through restricted access gateways without a need for authentication.

According to yet another particular embodiment, the server device further comprises de-segmentation and de-compression units configured to de-segment and de-compress received packets to reconstruct network information.

The present invention provides according to a second aspect a client device comprising:
a reception module configured to receive from an authentication server a connection message;
an analysis engine configured to analyze the received connection message;
a builder module configured to build network information based on the result of the analysis by the analysis engine of the received connection message;
a first sending module for sending build network information to an analysis server;
a reception module configured to received procedural information from the analysis server in response to the sent network information; and
a second sending module for sending an authentication message to the authentication server wherein the authentication message is constructed based on the procedural information received from the analysis server.

According to another particular embodiment, the analysis engine comprises means for filtering the content of the connection message received, wherein the filtering means removes presentation and/or style information from the content of the connection message prior to building network information.

The present invention also extends to programs which, when loaded into a programmable device, cause that device to become one of the devices described above. The program may be provided by itself, or carried by a carrier medium. The carrier medium may be a storage or recording medium, or it may be a transmission medium such as a signal. A program embodying the present invention may be transitory or non-transitory.

### BRIEF DESCRIPTION OF THE DRAWINGS

FIG. 1 depicts for illustrative purposes a communication system adapted to implement embodiments of the invention.

FIG. 2 depicts for illustrative purposes a block diagram illustrating a schematic configuration of a communication apparatus.

FIG. 3 illustrates a block diagram of a client device according to one embodiment of the invention.

FIG. 4 illustrates a block diagram of analysis server device according to one embodiment of the invention.

FIG. 5 is a flowchart illustrating a method of connection according to one aspect of the invention.

FIG. 6 is a flowchart illustrating a method of sending an analysis request to the analysis server.

FIG. 7 describes the handling of the procedural information received by the client device from the analysis server device.

FIG. 8 describes an example of operations performed by the analysis server upon reception of the log data sent by the client device.

FIG. 9 illustrates an information table located at the client device.

FIGS. 10 and 11 give two different examples of successful HTTP Requests sent to the same authentication server.

### DETAILED DESCRIPTION OF THE INVENTION

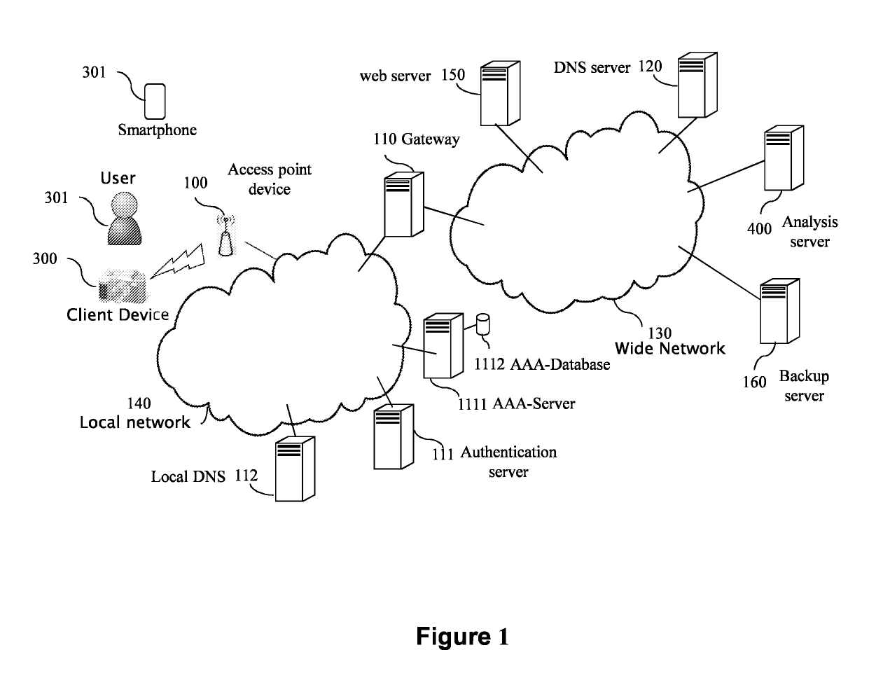

FIG. 1 depicts for illustrative purposes a communication system adapted to implement embodiments of the invention.

The communication system comprising a client device 300 that can connect to a local network 140. The client device 300 may be operated by a device user 301.

The connection between the client device 300 and the local network 140 can be achieved using at least one of the network interfaces of the client device 300.

According to one implementation example, the connection is established through a wireless link (Wi-Fi for example) between the client device 300 and an access point device 100 of the local network 140.

Alternatively, the connection is established through a wired link (Ethernet for example) to one device of the local network 140.

The client device 300 wants to access a server located on a wide area network 130 (e.g. Internet) such as a web server 150 for instance. The gateway 110 controls the communication between the local network 140 and the internet 130. The gateway 110 discards every packet sent using unauthorized protocol and/or sent by an unauthorized device of the local network 140.

To be able to communicate with the web server 150 using a standard web protocol like HTTP for instance, the client device 300 needs to be granted access to the Internet by an authentication server 111. User credentials may be needed for the authentication server 111 to grant Internet access, and the authentication server may rely on, for example, an authentication, authorization and accounting (AAA) server 1111 to check the validity of the credentials using a AAA database 1112.

In addition to the authentication server 111, a Local DNS server 112 is connected to the local network 140, and is freely accessible by any device connected to the local network. This Local DNS server 112 is able to forward some requests (such as an HTTP request) that cannot be locally processed (unknown domain name for example) to another DNS server 120 (or to a succession of DNS servers) located on the Internet 130.

To be granted Internet access by the authentication server 111, the client device 300 needs to follow a step-by-step connection procedure driven by the authentication server 111.

According to an embodiment of the invention, if the connection software installed on the client device 300 is not able on its own to successfully interpret (“understand”) and follow the connection procedure as expected by the authentication server, then the client device will seek the help or support of an analysis server 400. The analysis server 400 may have a better chance to successfully analyze the data provided, via the client device 300, by the authentication server 111 in response to requests made by the client device 300. Indeed, the analysis server 400 is a centralized server that may have more processing resources and can be updated more frequently. The analysis server 400 can thus benefit from more up-to-date parsing and analysis algorithms and data than the client device. The client device is usually a device with limited resources and which software is more difficult to update like a camera for example.

The analysis server 400 can be located on the internet 130 or on any network accessible to the client device 300. When located on the wide area network 130, the communication between the client device 300 and the analysis server 130 should use authorized protocols (like DNS discovery protocols) to go through the gateway 110.

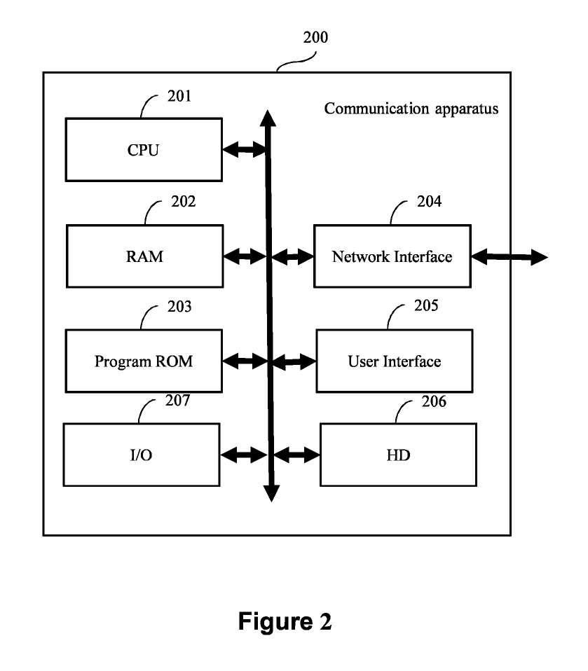

User 301 can enter information (such as credentials or any other personal information) in the client device 300 through a client user interface (for example unit 205 in FIG. 2). The user interface may enable the user to backup device information on a backup server 160.

In alternative embodiments, such information can be entered through other means than a user interface, such as synchronization with information stored on another device, such as a smartphone 301, using a wireless link.

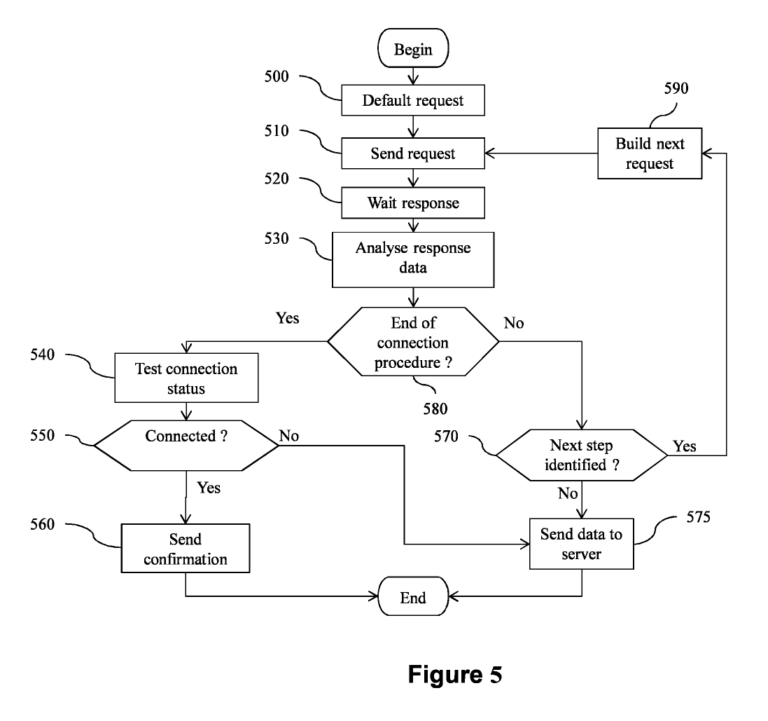

FIG. 2 depicts for illustrative purposes a block diagram illustrating a schematic configuration of a communication apparatus 200 representing a transmitting device or a receiving device (such as the client device 300 or the analysis server 400) adapted to incorporate embodiments of the invention. Reference numeral 202 is a RAM which functions as a main memory, a work area, etc., of CPU 201, and the memory capacity thereof can be expanded by an optional RAM connected to an expansion port (not illustrated). CPU 201 is capable of executing instructions from program ROM 203 on powering up the communicating apparatus. After the powering up, CPU 201 is capable of executing instructions from the main memory 202 relating to a software application after those instructions have been loaded from the program ROM 203 or the hard-disc (HD) 206 for example. Such software application(s), when executed by the CPU 201, causes the steps of the flowcharts shown in any one of the FIGS. 5 to 8 to be performed.

Reference numeral 204 represents a network interface that can be a single network interface, or composed of a set of different network interfaces (for instance several wireless interfaces, or different kinds of wired or wireless interfaces). Data packets are written to the network interface for transmission or read from the network interface for reception under the control of the software application run by the CPU 201. Reference numeral 205 represents a user interface to display information to, and/or receive inputs from, a user. Credentials may be input for example by the user through the user interface 205.

I/O module 207 represents a module able to receive or send data from/to external devices (like video source or display).

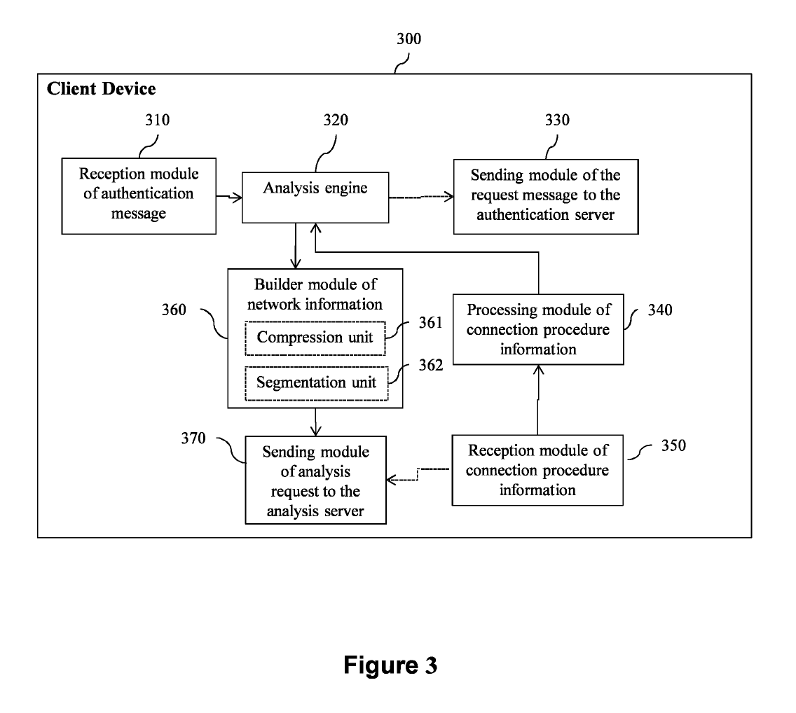

FIG. 3 illustrates a block diagram of client device 300 according to one embodiment of the invention.

Unit 310 is a reception module of the authentication message. It is in charge of receiving the response information issued by the authentication server 111. Typically, this response information is a response to a request sent by the device client 300 to the authentication server. The response information could also be some redirection request to the device client as a response to request for a web page for instance. This information may contain web page code (for instance HTML content, JavaScript or XML content), or a redirection URL for instance.

The analysis engine module 320 is in charge of processing inside the client device 300 the information received by the reception module 310 and of filtering the relevant information for obtaining Internet access.

For example, this analysis module 320 is in charge of selecting the data which is relevant for the determination of a connection procedure from the data which is only related to presentation or display purposes (data display organization, style, etc.). Then, the analysis module 320 will determine which connection procedure to use. The analysis module 320 can then send a request to sending module 330 in order to send the request to the authentication server 111. If the analysis module 320 cannot determine the next step (such as a request message) to be performed in order to be granted access to the internet, it can decide to send all or part of the data to the analysis server 400 on the internet, using an authorized protocol. This analysis module 320 is also capable of receiving a list of one or more requests prepared by the processing module 340, and handles the corresponding connection procedure. To handle a prepared connection procedure, the analysis module 320 sends the requests one by one to the sending module 330, and checks the corresponding response to be received by the reception module 310.

Builder module 360 is the module in charge of building information to be sent to the analysis server 400, which includes an analysis request type and accompanying network information. The analysis request type is for example “propose request message to be sent to the authentication server”, and can be identified by an identifier understood by the analysis server.

First, the builder module 360 is in charge of determining the possibility to communicate directly with some server located on the internet. For instance, this builder module 360 could probe a set of network protocols in order to determine which protocol is authorized to access the internet, and then evaluate the payload size of each authorized protocol. After the determination of the direct communication possibility, the builder module 360 will fetch all the information selected by the analysis engine 320 during the sequence of connection, and will prepare the information to be sent to the analysis server 400.

Two additional modules can then be used, by the builder module 360, to optimize the preparation of the data. The first additional module is the compression module 361 which is in charge of the lossless compression of the selected data (HTML data for instance). HTML data is quite easy to compress, since this kind of data comprises text. It is then easy and very useful to compress the data before sending it in order to reduce the bandwidth required for transmission. The second additional segmentation module 362 is in charge of segmenting the compressed data into payloads with sizes below the maximum payload size allowed by the protocol used, determined during the communication possibility determination.

The sending module 370 is responsible for sending the data prepared by the builder module 360. The sending module 370 uses the protocol determined by the builder module 360, and sends the prepared data to the analysis server 400.

The reception module 350 receives the responses from the analysis server 400. Those responses can be some acknowledgment of the segments sent by the sending module 370, or some connection procedure information issued by the analysis server 400 as a response to the analysis request sent by the sending module 370. This reception module 350 is also in charge of requesting a retransmission of some segment of data lost during the transmission (ARQ mechanism), based on the acknowledgment received or not from the analysis server 400.

The processing module 340 is in charge of processing the connection procedure information received from the reception module 350. The processing module 340 prepares a list of one or more requests to be sent to the sending module 330 by the analysis engine 320. The processing module 340 extracts one or more request messages included in the connection procedure information, and instantiates the request messages by inserting missing information which is locally stored (credential information, or other personal information stored on the client device 300) in the request template at some specific place marked by dedicated marker (specific character sequence for instance). Then the processing module 340 sends the list of requests to the analysis engine 320. The processing performed by the modules listed in FIG. 3 will be further detailed here below (FIGS. 5, 6, 7 and 9).

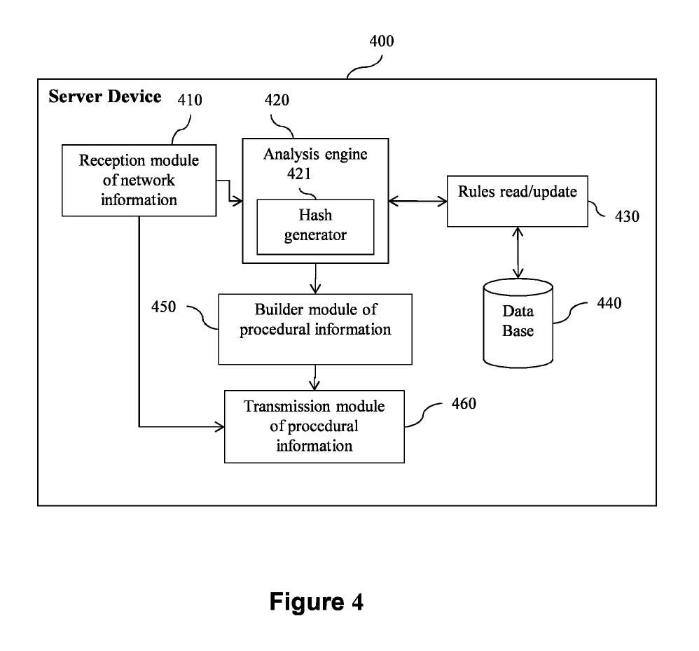

FIG. 4 illustrates a block diagram of analysis server device 400 according to one embodiment of the invention.

Module 410 is in charge of the reception of the analysis request sent by the client device 300. The reception module 410 will extract the segment included in the payload of each frame received, and reconstruct the data to be analyzed. If the data has been compressed by the client device 300, then the reception module 410 is in charge of decompressing the data. Once the data is decompressed and reconstructed, the data is sent to the analysis engine 420 for analysis purposes. The reception module 410 is additionally also in charge of sending an acknowledgment for each received segment to the client device.

The analysis engine 420 is in charge of the analysis of the data sent by the client device 300, which includes for example an analysis request type and accompanying network information. The network information contains the log of the data received from the authentication server during the connection session between the client device 300 and the authentication server 111 (including all the error information returned by the authentication server in case of failure during the connection session).

For performance optimization reasons, the analysis engine 420 may include an additional module 421 (such as a hash generator) able to compute a hash of the received data. The analysis engine module 420 can then request the rules handler module 430 to retrieve some previous results of the analysis of the current data (if it exists). This mechanism avoids the analysis of a given data already analyzed by the analysis engine 420 following a previous request received either from the same client device 300 or another device.

This is also a learning mechanism. When the authentication procedure is the same at several hotspots or wireless access points (example of a set of hotspots newly deployed by the same provider for instance), as soon as the analysis has been performed once, the results are stored, and every client device with an obsolete version of the software will quickly receive the correct connection procedure. The server only has to compare the received hash to the one stored in the rules database to retrieve the useful connection information.

The rules handler 430 is in charge of managing the storage and update of the rules in the database 440. The rules can be inserted and/or updated after an automatic analysis by the server software. After reception by the server of the connection results by the client device, the rules handler 430 can also remove the rule from the database if they proved not to be successful for example.

The database 440 stores the rules determined by the analysis engine 420 or added after offline analysis of the failure information (after upgrade of the analysis algorithm or human interpretation of the received information).The rules handler 430 can also contain some logout information (the URL to use to logout). This information can also be sent to the client device by the analysis server 400.

The builder module 450 is in charge of the building procedural information to be communicated to the client device 300 in a response to client analysis request. The procedural information may include a template request that needs to be instantiated (replacing certain place holders) by the client device or an already formed instance that just needs to be transmitted by the client device to the authentication server 111.

The transmission module 460 prepares the connection procedure information to be sent to the client device. For example, if the DNS protocol is used, the transmission module 460 inserts the connection procedure information in one or more DNS response frames that will be sent to the client device. If required, the procedural information can be compressed and segmented in order to fit the capacity of the DNS response frame format.

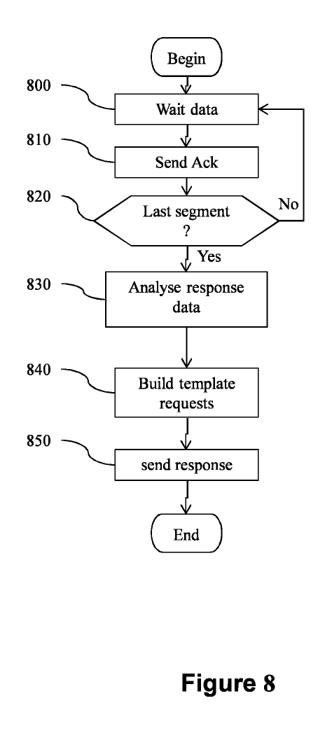

The processing performed by the modules listed in FIG. 4 will be further detailed in FIG. 8.

FIG. 5 is a flowchart illustrating a method of connection according to one aspect of the invention. The steps may be performed, for example, by communication apparatus 200 acting as the client device 300.

The steps may be implemented in hardware, software, firmware or any combination thereof. If implemented in software, the flowchart may correspond to a segment of the program stored in the ROM 203 of first device 200.

When a client device wants to connect to a network requiring an authentication procedure (such as a wireless hotspot for instance), the connection algorithm described in FIG. 5 will be executed. This algorithm uses various modules previously described in FIG. 3.

In order to obtain Internet access from the Authentication server 111, the client device 300 must generate a connection request sequence driven step-by-step by the Authentication server 111. The connection request sequence is a sequence of one or more requests which are sent to the Authentication server 111 in order to be granted Internet access. Each request in the sequence triggers a response from the Authentication server, which is received by the reception module 310. The composition of each request is based on analysis of the Authentication server responses from the previous client device requests, and is performed by the analysis engine 320. Each request in the sequence is generated by the sending module 330.

An example of such requests are HTTP requests (of various types), comprised of Universal Resource Locators (URLs) and varying sets of parameter/value pairs. Examples of HTTP request types are HTTP GET requests (comprised of a URL) and HTTP POST requests (comprised of a URL and POST parameter/value pairs). HTTP Requests (whether they are GET or POST requests) include parameters, such as User Agents which identify the client device type to the Authentication Server and may trigger different responses (and enable different login procedures) from the Authentication Server.

First, step 500 determines the first request to be sent to the authentication server. This request can be stored in the device during the installation of the software, or configured manually by the user for instance. Typically, the request is an HTTP GET request for a predefined default URL (like http://www.google.com for instance).

For this first request 500, the user agent parameter, which identifies the type of application and/or device that is generating the request, is set to a default value (first user agent value). This default value can be set during the installation of the analysis engine on the device or set by the user at any time, or selected by the user from a predefined list. A typical default value for the user agent parameter is for instance the user agent value corresponding to a classical web browser like Internet Explorer or Mozilla Firefox. The default user agent value is selected from a predefined list of user agent values stored in the client device.

In an alternate embodiment, in case of failure to obtain a desired type of network information from the authentication server (such as, for example, the presence of a <WISPAccessGatewayParam> XML tag in the HTML content returned by the authentication server, indicative of compliance with the WISPr, or Wireless Internet Service Provider roaming, protocol) using a first user agent value, the analysis engine can select another user agent value from the predefined list of user agent values, and use it in its requests, until it obtains the desired type of network information.

Then step 510 sends the request (provided by the execution of step 500 or step 590) to the authentication server, and stores it in a local memory in the client device (called log memory in the following).

Step 520 then waits for a response to this request from the authentication server.

Step 530 first stores in the log memory the information received.

If the response is a redirection request, then the result of the analysis is successful, and the next request to be executed is the redirection URL received in the data.

If the information received at step 520 is representative of a connection failure (HTML error code for instance), then step 530 will select the next connection procedure and the credential to be used among the ones(s) not already tested.

Step 530 analyses the response data returned by the authentication server to identify possible connection procedures.

Step 530 is able to determine from the response data which connection procedure(s) may be used: there may be more than one. In some cases, only one connection procedure may be used, in others, more than one connection procedure may be used.

Two examples of connection procedures are the WISPr connection procedure and the HTML FORM connection procedure. There exist other connections procedures, not described here, but which a person skilled in the art can identify from examining the response data from the authentication server.

For example, the presence of the <WISPAccessGatewayParam> XML tag (which we refer to as the WISPr tag) in the HTML content returned by the authentication server indicates that the authentication server is compliant with the WISPr protocol, and indicates that one possible connection procedure is the WISPr connection procedure. The WISPr connection procedure is detailed clearly in the WISPr recommendations.

In another example, the presence of the <FORM> HTML tag in the HTML content returned by the authentication server indicates that one possible connection procedure is the HTML FORM connection procedure.

Step 530 has the ability to determine the order in which each identified possible connection procedure will be used. There may be many ways to select which connection procedure to start with first when there are at least two options. One such way is to select the connection procedure which is the easiest to implement, such as the WISPr connection procedure, which has been designed to simplify automatic connection to wireless hotspots. Another way is to select first the connection procedure which, from experience, has been successful with a larger number of credentials. For example, some authentication servers will return responses which indicate compliance with the WISPr protocol, but will either not accept credentials from any Wireless internet Service Provider (WISP) or will accept credentials from only a very limited number of WISPs, in comparison with other connection procedures (such as HTML FORM).

Step 530 therefore maintains an ordered list of possible connection procedures identified from examining the response data from the authentication server.

Step 530 also determines if credential information is needed. Step 530 also determines the logout procedure, in the cases where that information is made available by the authentication server.

Step 530 also has the ability to analyze the response data to identify which credentials in the credential list might have a better chance of being granted Internet access by the authentication server. It is therefore capable of producing an ordered list of credentials to be used, from the list of credentials stored in the client device. By default, the ordered list of credentials is the list of credentials stored in the client device.

For example, if the WISPs “Orange” and “BTOpenzone” appear in the response data, then step 530 would put, if they can be found in the client device, credentials corresponding to WISPs “Orange” and “BTOpenzone” on top of the list.

The ordered list of credentials may vary depending on which connection procedure is in progress.

The ordered list of connection procedures and the corresponding lists of credentials are initialized each time the client device wants to access the Internet from a new local network.

Step 580 will determine whether the connection procedure has reached its end.

If it has reached its end, then step 540 will try to access the internet, for example by trying to access the predefined default URL (execute a get request on the corresponding URL).

Step 550 determines the result of the internet access tentative performed at step 540 (by checking a specific part of the returned page for instance). If the connection is not established, step 575 will be executed; otherwise step 560 will be executed.

Step 560 first determines if the step 740 (instantiation of a connection procedure received from the server analysis) have been executed at least once for the current connection sequence. If yes, a confirmation of connection is sent to the analysis server. This could be done by using the same transmission mechanism used on step 580, or by a direct access via the internet (since the access is internet connection is now possible).

If Step 580 determines that the connection procedure has not reached its end, then it goes to step 570.

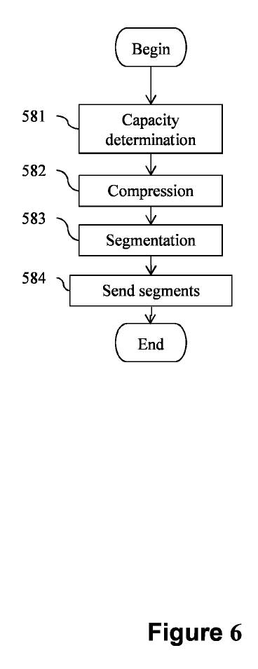

In step 570 if the local analysis engine successfully determined the following action to be performed (analysis is successful), step 590 is executed, otherwise (analysis is failed), the data will be sent to the remote analysis server in step 575 (further detailed in FIG. 6).

Step 590 prepares the request to be sent to the authentication server, based on the analysis results of the step 530. Depending on the connection method determined on step 530, step 590 will trigger different types of action. For example: if the connection method determined is a WISPR connection method, the step 590 will recover the WISPR tag found during the step 530 execution, and extract the useful login and or logout URL required to establish and/or closed a connection using the WISPR protocol. Then step 590 will use the credential information determined by the step 530 to customize the WISPr connection request as described by the specification provided by the Wi-Fi alliance.

If the connection method determined by the step 530 is a FORM method, then, the step 590 will recover the content of the <Form> tag found during the analysis of the data received by the authentication server, and create an http post request. Then, the step 590 recovers the value of the attributes METHOD, ACTION, and INPUT, to create the request to send to the authentication server. The value of the input field will then be populated using the credentials information selected in step 530 (user name, password, service provider, personal information like name or phone numbers, etc.).

If the connection method is set to DEFAULT, step 590 select the next user agent in the list of the user agent, and build a new http get method for the predefined default URL, with the user agent field set with the new user agent value.

Then step 510 is executed.

FIG. 6 is a flowchart illustrating a method of sending an analysis request to the analysis server 400. It corresponds to one implementation example of step 575 of FIG. 5.

If it is the first time that step 581 is executed, step 581 determines the capacity of direct transmission to the internet (without being granted by the authentication server for http communication). To do so, step 581 sends a predefined set of request to the remote server 120. This set of predefined request can be some ping request, DNS, or EDNS query, or other standard protocol. Depending on the response received to those query or requests, the step 581 determine which protocol is supported (if any), and what is the maximum size of the payload of the determined protocols. This payload determination also takes into account the fact that a part of the payload may be required for the protocol itself, in order to have a well formatted frame. For example, in the case of the DNS protocol, the beginning of the payload should be formatted as a DNS domain name query (with a specific domain name which is only known by a specific DNS server located on the internet). If no protocol is supported, this means that there is no way to send data to the remote server without being granted by the authentication server. In that case, the log is store locally on a long term memory (SD cards, hard disk, etc.) to be sent to the server as soon as a connection is available.

If step 581 determines that at least one protocol can be used to transmit data to the remote server, the step 582 is executed.

Step 582 compress the data stored in the log to reduce the needs in term of bandwidth for a transmission of this data. The compression method can be very basic (usage of some free compression library like zlib, or Icompress for instance), and applied directly on the complete log data, or more complex (for instance based on some HTML tag dictionary, in order to compress more efficiently the HMTL tags). In addition, the information which is not useful to determine a connection method or the associated request can be removed before compression. This removal can be based on a classification of the useful HTML tag for instance (all the tag dedicated to the presentation of the data like the style sheet for instance can be safely removed from the useful data). Of course, some other html compression method can be used, the example described here are not limitative.

Then step 583 is executed. Step 583 will divide the compressed data in several parts, each of the parts having a maximum size corresponding to the payload size determined in step 581. Each created part is then numbered in order to be recombined at the reception side, and the total number of fragment is also added.

Step 584 prepare for each parts created by the step 583, a frame of the protocol determined in step 581, by adding the part dedicated to the protocol itself, and then the segment of data created in step 583. Of course, the part of the payload dedicated to the protocol depends on the protocol determined on step 581. As explained in step 581, in the case of DNS for instance, this part can be a DNS query to resolve a specific address only known by a specific DNS server. Then step 584 sends the prepared frame to the remote analysis server. Depending on the type of transport protocol used (TCP or UDP), step 584 can also start a timer that can be used for retransmission purpose.

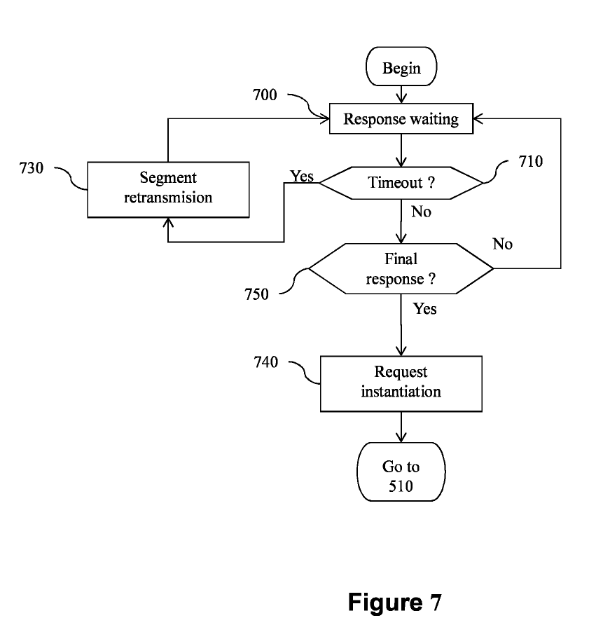

FIG. 7 describes the handling of the procedural information received by the client device from the analysis server device.

Depending on the transport protocol used to send the data in step 583 (UDP for DNS for instance, or TCP for other protocol), it can be useful to have a retransmission mechanism for some potentially lost segment of data (case of UDP transmission). In that case, steps 710 and 730 are executed. Otherwise, on data reception in step 700, step 750 is directly executed.

Step 710 determines if the sending of one segment failed (corresponding timer has ended), and then the corresponding segment is retransmitted to the server (same procedure that the one performed in step 584). If no timer has ended before the reception of a response, step 750 determines if the response is only an acknowledgement of a segment of data, or if this response contains some procedural information that can be used by the client to determine the next request to send to the authentication server.

If the procedural information received from the server contains at least one login template request, step 740 instantiates the first request by replacing the special character string contained in the template request by the corresponding local credential information or personal data. For instance, the login and password information will respectively replace the special character string %C_LOG and %C_PWD.

Once the request is completely instantiated, the request is sent to the step 510 to be used as the new request to be sent to the authentication server. If the procedural information received contains more than one template request, the other request(s) are also instantiated (including the logout requests), and could be used in case of failure of the current request. In another embodiment, the set of received request can also be used as a login sequence (each request being part of the same login sequence); the instantiated logout requests being used when the user decides to disconnect from the authentication server.

In another embodiment, step 740 determines if the procedural information includes information messages for the user, and communicates the received message (potentially instantiated like a login or logout request) to the user. The message communication can be done by displaying the message and/or by writing the message in a log.

FIG. 8 describes an example of operations performed by the analysis server upon reception of the log data sent by the client device in step 580.

Step 800 waits for a data segment sent on step 584. It is important to notice here, that this data segment can be directly received from the device client, or forwarded by a dedicated server located on the internet, and able to act like a server of the protocol determined in step 581 (for instance, a DNS server).

Upon reception of a segment of data, step 810 sends an acknowledgement containing the number of the received segment (only if the transport protocol is UDP like in the case of the usage of DNS). This acknowledgement is encapsulated in a response frame of the protocol determined in step 581 (like a DNS response for instance).

Then step 820 determines if the total number of fragment received corresponds to the expected number (inserted in each fragment in step 584). If every fragment is well received, step 830 is executed.

Step 830 reconstructs the log data by defragmenting the data, and decompressing the defragmented data. Then, the remote analysis engine will analyze the data.

The purpose of this analysis is to determine the connection methods that are available for the authentication server (based on the log information). The analysis algorithm is very similar to the one described in step 530, but the parsing algorithm could have been updated on the server, so the result of the analysis can be different and the connection determination more accurate.

Then step 840 is executed.

Step 840 is in charge of the creation of the procedural information that will be sent to the client device. This procedural information contains one or more template request to be used by the client device (to obtain a granting from the authentication server), and can also contain one or more template request to be used for the logout procedure.

Step 840 produces a template request for each connection method determined in step 830. A template request is similar to the request generated by the client device in step 590, except that the analysis server doesn't have any credential information (login, password, etc.) nor any personal information of the remote user. So, instead of filling the value of the form or of the WISPR request, with the personal information or credential information, step 840 replace those information with a specific character string representative of the missing data. For instance, the missing login could be replaced by the string %C_LOG, and the missing password by %C_PWD. The same mechanism, known by both the client device and the analysis server, can be used to indicate each item of personal information or credential information. Step 840 can also potentially create a template request for each logout URL found in the rules database for the current authentication server. The procedural information (including the created template requests) is then sent in one or more query responses as described in step 810.

In another embodiment, the rules database can also contains information message for the user of the client device. This message can be used to inform the user of the cause of the failure of the connection sequence, or to help the user to obtain the required credential (for instance to ask to the cashier the credential information).

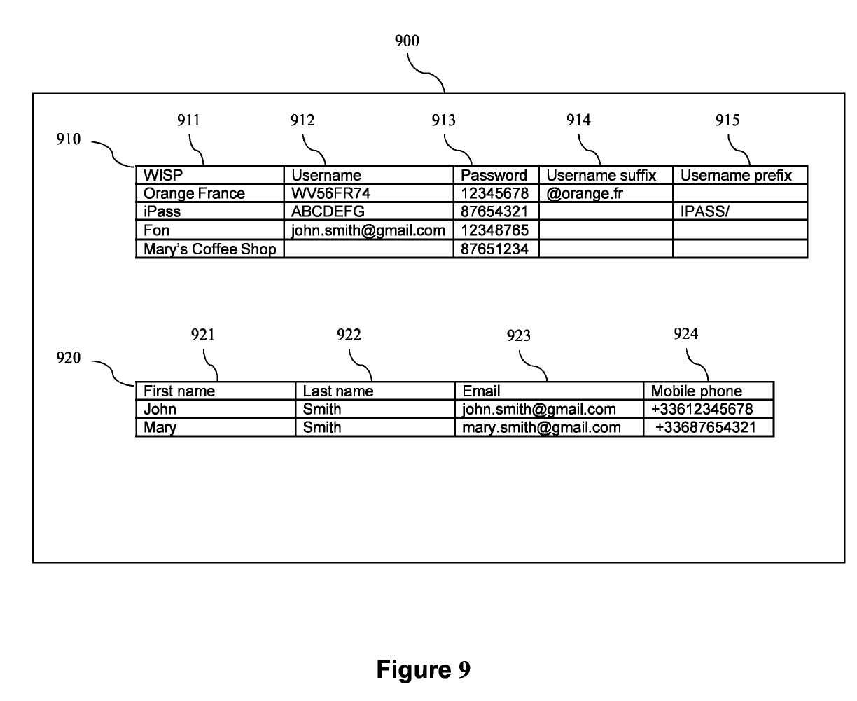

FIG. 9 illustrates an information table located at the client device. This table is for example stored in memory RAM 202.

The information entered by the device user (such as credentials—username and/or password—or other information) using the device user interface is stored in a device information table 900. The device information table 900 contains credential information 910. It may also contain device user personal information 920 (such as first name, last name, email address and mobile phone number). In alternative embodiments, it may contain other types of information.

The credential information 910 is needed to be granted Internet access from Authentication servers 111 from some WISPs, and is typically used by the Analysis engine 320, and the Analyse Response data module 530. It is used, either in requests generated by the client device by the Analysis engine 320 independently of the analysis server 400, or to fill request templates generated by the analysis server 400 and received by the client device. Credential information 910 is stored in the client device 300.

FIG. 9 gives non limitative examples of credential information for four Wireless Internet Service Providers (WISPs). Some WISPs may only require a password (or alternatively a username) to obtain Internet access from the Authentication server 111. Some WISPs may require the use of username suffixes and/or prefixes, for example when trying to obtain access from a WISP using credentials from a different WISP, thanks to a roaming agreement between both WISPs.

The credential information 910 is a table containing a list of credentials, which are being used by the device user to obtain Internet access from an authentication server 111. Each credential may contain any combination of username 911, password 912, username suffix 914, username prefix 915, Wireless Internet Service Provider (WISP) 911. There may be more than one set of credential for every WISP, which would correspond to more than one row in the credential information table 910 for the same WISP.

When creating any request (such as an HTTP Request) to the authentication server, for those authentication servers requiring the use of credential information, then a username and/or password needs to be inserted in the request (for example as values of parameters of an HTTP POST request). The value of the username parameter can have multiple forms, depending on the authentication server, and the correct form is not necessarily known in advance. The ability to generate a variety of usernames for the same WISP is needed, because different WISPs may have different syntax requirements concerning usernames for a given WISP. This is why the ability to compose various versions of the username to be inserted in the request(s) to be tested is needed.

One can for example use the username value 912 alone as the username value to be used in the request. One can also concatenate the username prefix 915 and the username 912 to form the username used in the request. One can also concatenate the username 912 and the username suffix 914 to form the username used in the request. One can also concatenate the username prefix 915, the username 912 and the username suffix 914 to form the username used in the request.

For example, using the Table 910 above, one WISP (such as Orange France®) may consider WV56FR74 to be a valid username for Orange France, while other WISPs may consider WV56FR74@orange.fr to be a valid username for Orange France.

The username and password can be obtained by the user directly from the WISP. The Username prefix and/or suffix can usually be obtained from the corresponding WISP, or partner WISPs with which it has roaming partnerships.

FIG. 9 also contains device user personal information 920 in the form of a table. This table contains a First name field 921, and a Last name field 922. It also contains an Email field 923, and a Mobile phone field 924. Device user personal information may be needed by some authentication servers which instead of requiring credential information for any given WISP, will grant free Internet access if personal information such as described in 920. The selection of which row of 920 to be used can be made by the user via the device user interface. Personal information such as the Mobile phone may be needed to receive credential information to be used at a hotspot location, which can then be entered by the user into the client device.

There can be more than one user in client device user personal information 920, and there can be more than one row for a single user (for example if the user has several email addresses or mobile phone numbers).

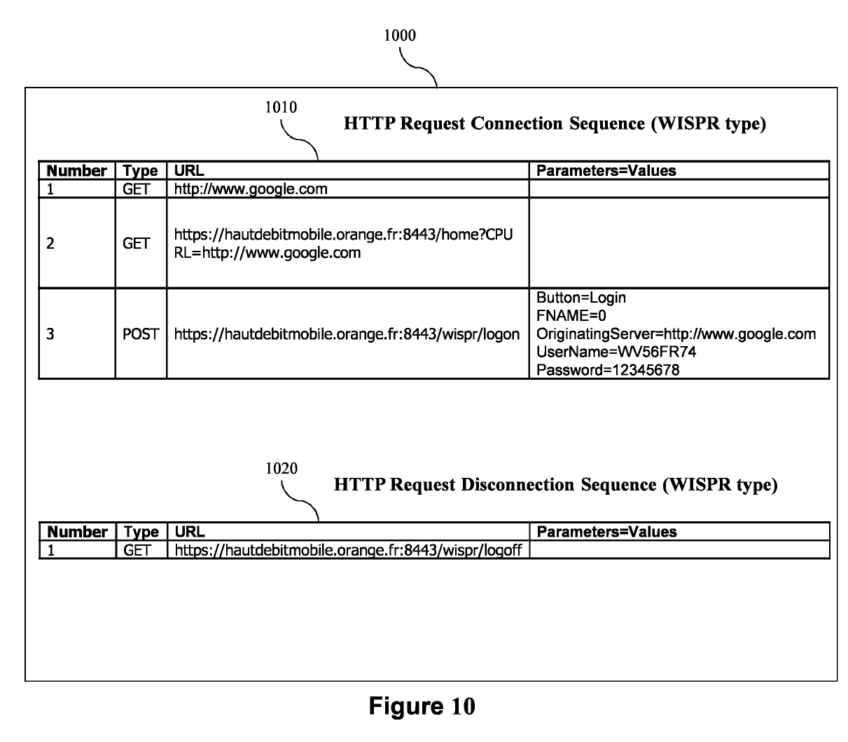

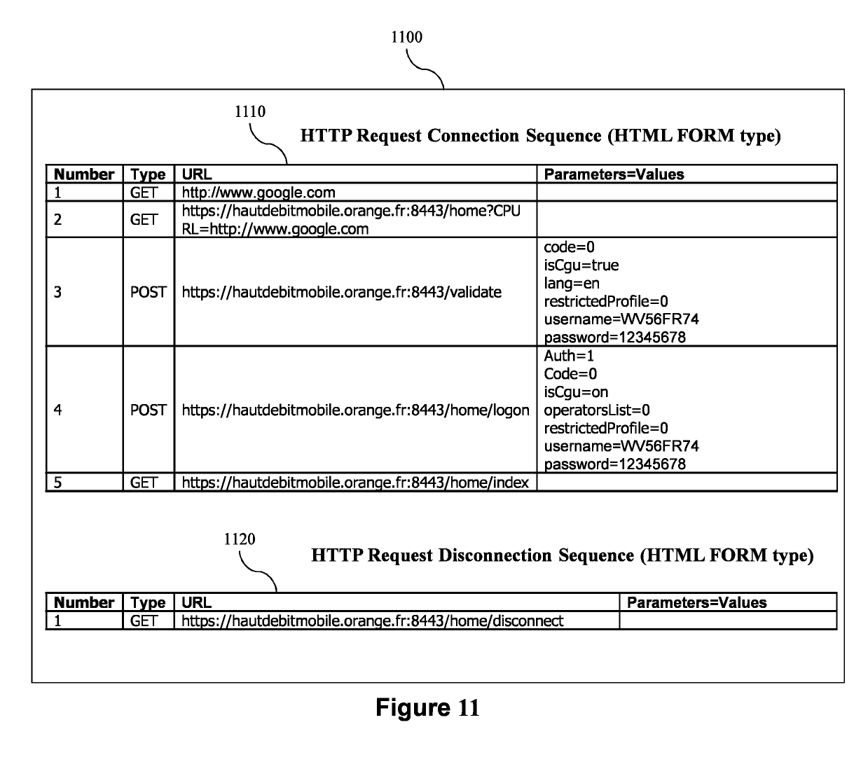

FIGS. 10 and 11 give two different examples of successful HTTP Requests sent to the same Authentication server by WISP Orange France. Such request sequences illustrate two different ways (using two different connection procedures such as WISPr and HTML FORM) in which a device can successfully be granted Internet access by a given authentication server.

Table 1010 of FIG. 10 lists the three requests (the HTTP Request Connection Sequence) needed to be granted Internet access by the Authentication Server 111 using the WISPr connection method.

The first request is a default HTTP GET request to the URL http://www.google.com. The (first) response from the authentication server is a redirection request to the URL https://hautdebitmobile.orange.fr:8443/home?CPURL=http://www.google.com and also includes HTML content, itself containing WISPr XML code with the WISPr LoginURL https://hautdebitmobile.orange.fr:8443/wispr/logon.

The second request is an HTTP GET Request to the URL https://hautdebitmobile.orange.fr:8443/home?CPURL=http://www.google.com as directed by the authentication server. The second response from the authentication server contains HTML content, but no redirection request.

The third request is an HTTP POST request to the URL https://hautdebitmobile.orange.fr:8443/wispr/logon, using standard WISPr parameters with fixed values (such as Button, FNAME), and other WISPr parameters and values taken from the credential information table 910, as well as the default URL (http://www.google.com). The authentication server response includes WISPR XML information confirming Authentication success, as well as providing the WISPr LogoffURL to be used when the client devices wishes to disconnect itself from the network, to be used in Table 1020.

Table 1020 of FIG. 10 lists the single request (the HTTP Request Disconnection Sequence) needed to disconnect from the network using the WISPR connection method.

Table 1110 of FIG. 11 lists the five requests (the HTTP Request Connection Sequence) needed to be granted Internet access by the Authentication Server 111 using the HTML FORM connection method.

The first request is a default HTTP GET request to the URL http://www.google.com. The (first) response from the authentication server is a redirection request to the URL https://hautdebitmobile.orange.fr:8443/home?CPURL=http://www.google.com.

The second request is an HTTP GET Request to the URL https://hautdebitmobile.orange.fr:8443/home?CPURL=http://www.google.com as directed by the authentication server. The second response from the authentication server contains HTML content, but no redirection request. The HTML content contains the HTML FORM tag, with the METHOD POST, and the information needed to perform the next two requests.

The third and fourth requests are HTTP POST requests to the URL https://hautdebitmobile.orange.fr:8443/wispr/logon, using standard WISPr parameters with fixed values (such as code, isCgu, lang, restrictedProfile, operatorslist), and other WISPr parameters and values taken from the credential information table 910. The authentication server response to the third request is simply OK, while its response to the fourth request includes the LogoffURL to be used when the client devices wishes to disconnect itself from the network, to be used in Table 1120.

Table 1120 of FIG. 11 lists the single request (the HTTP Request Disconnection Sequence) needed to disconnect from the network using the HTML FORM connection method.

As a summary of the operations of the devices according to embodiments of the invention, client device 300 embeds an analysis engine 320 (called local analysis engine in the following) able to parse the data received from the authentication server 111 to determine the connection sequence to be executed in order to be granted access to the Internet by the authentication server. In case of failure of the local analysis engine (parsing error of the data received, wrong format of the generated request, etc.), the client device sends at least a part of the information received from the authentication server to the remote analysis server 400 located on the internet. The information is sent to the remote analysis server via a tunneled communication (encapsulation of the data in the payload of one or more packets of a protocol allowed by the gateway to access the internet). If all the data cannot be sent in one packet, the client device can compress the data and segment the compressed data to fit the payload of the encapsulating protocol. Upon reception of the data, the remote analysis server sends the data to its (remote) analysis engine (that is more up-to-date than the local analysis engine) and returns the result of the remote analysis to the client device. The result sent to the client device doesn't contain any information related to the client device or its owner or user (no credential information nor user identifier for instance), since this information is present on the client device. The return information only contains a request template (such as an HTTP Request template) that needs to be instantiated by the client device in order to fill the request template with missing information which is preferably stored on the client device (such as credentials—for example username and password—, and other personal information for instance). For performance optimization purposes, the analysis server can store a hash of the received data and the result of the corresponding analysis in a cache database. This allows avoiding further unnecessary analysis of data previously analyzed, by the client device or by the analysis server. Upon reception of the analysis results, the client device instantiates the received connection sequence, and executes this sequence by sending the instantiated requests to the authentication server. After the completion of the connection sequence, the client device sends the results of the connection to the server (success or failure, and possibly any response message from the authentication server). This latest information can then be stored by the analysis server in its cache in order to validate the analysis, or to indicate a failure by the remote analysis engine (to be updated in the next update of the algorithm).

According to a particular embodiment, the following list of means can be used.

Means on the sender side:
Means to connect to an Access Point (get IP address)
Means to request a pre-defined web page (HTTP GET request)
Means to analyze the HTTP request response
Means to identify one or more possible methods of connecting (such as WISPr, or HTML FORM) based on analysis of the HTTP request response
Means to reduce size of HTML content by parsing and storing only information relevant to Login or Logout
Means to create an HTTP Login request to be sent to the authentication server based on analysis of a HTTP request response
Means to connect using determined request sequence
Means to test Internet connection access.
Means to send HTML page and request response via a DNS tunnel.
Means to receive an (HTTP request) in a DNS response.
Means to fill (HTTP) request template sequence with credentials and other info, stored on the client device
Means to backup client device information (such as credentials, personal information)
Means (for the user) to enter credentials or other info on the client device
Means to store credentials or other info on the client device
Means to compose username

Means on the receiver side:
Means to parse HTML page to get automatic connection mechanism (WISPR code, form to fill, etc.)→request sequence to send.
Means to format and send back connection sequence to the sender.
Means to populate and update local database

According to one particular implementation, there is no connection sequence known a priori; the connection sequence is the sequence of HTTP requests made to the authentication server, and is only known at the end of the series of HTTP Requests and responses; what is generated, step-by-step, taking into account information sent from the authentication server, is ONE single HTTP Request at a time; so the server cannot send a full connection sequence all at once to the client device, it needs to do it step-by-step, and analyze each HTTP response before making another request.

According to further embodiment, the following list may be used alone or in combination of the previous list of means:
Tunneling capacity evaluation
   Determination of the tunneling capacity (classical DNS=512 Bytes, but EDNS allow up to 2 KB).
   Acknowledgement of each DNS request (data segment) to be used as ARQ mechanism.
Cache handling
   Aging/Validity over time of credential usage request for a given place (hash for a page)
   Avoid caching by the local DNS server by adding unique id in the DNS request.
Page Compression
   Generic data compression method (zip)
   Specific compression method based on dictionary for instance.
Interaction with user (popup, message . . . ) indicating data useful for the connection (pwd or password missing, credential not found etc.)
Differed request sending in case of connection failure (to feed the server learning mechanism)
Usage of several user agents.
Storage of the logout URL at the server side (can be requested after connection using classical HTTP request to the server)

In the different embodiments of the inventions the following advantages can be obtained.

Increased Connection Success:
Feature: credentials are stored on the client device, and can be entered by the client device user via a user interface.
Advantage: if credentials are not known in advance (such as the first time at a hotspot with credentials provided at the hotspot location), they can be entered directly at the hotspot; in situations where the credentials are stored on a web server, Internet access is required to be able to upload the credentials to the web server (impossible since no Internet access), and even if the credentials already exist on the web server, then failure to connect to the web server will not enable access to the needed credentials.
Benefit: the client device user can connect to more hotspot access points.

Optimized use of help of the web server:
Feature: help in analyzing network information from the analysis server is only requested after connection attempts by the client device have failed
Advantage: no dependency of the client device on the analysis server in common cases, dependency only for the more complex cases or the cases for which the software on the client device is not up-to-date.
Benefit: faster connection to the hotspot access point for the less complex cases.

Better credential management 1:
Feature: the client device is able to try different combinations of credentials, even for the same WISP, by using username prefixes and suffixes.
Advantage: the client device can adapt to different credential syntaxes required by different WISPs.
Benefit: increased chances of successful connection.

Better credential management 2:
Feature: relevant user personal information can be entered in the client device, including mobile phone information.
Advantage: in cases where credentials are not needed a priori, the client device can use personal information to obtain either Internet access or receive (such as via mobile phone) credential information at the hotspot location.
Benefit: increased successful connection cases.

Preferred connection methods:
Feature: The client device can (1) identify available connection methods, and then (2) select preferred connection method based on various criteria.
Advantage: the client device can select the connection method best suited for a hotspot wireless access point.
Benefit: faster connection is achieved.

1. A server device comprising:
a reception module configured to receive from a client device network information, the network information containing at least part of a message transmitted to the client device by an authentication server;
an analysis engine configured to analyze the network information based on a set of rules;
a builder module configured to build procedural information based on the result of the analysis, the procedural information containing instructions adapted to configure the client device to reply to the message sent by the authentication server; and
a transmission module configured to transmit the procedural information to the client device.

2. The server of claim 1, wherein the set of rules are centrally updated at the claimed server to adapt the configuration of the analysis engine to network information resulting from messages of various types and transmitted by one or a plurality of authentication servers.

3. The server of claim 1, wherein network information contains information obtained from several messages transmitted by the authentication server, each message being transmitted in response to a request message sent by the client device in which a distinct application identifier has been included.

4. The server of claim 1, wherein the received network information is compressed and segmented in a plurality of packets, each packet being formatted as a DNS packet.

5. The server of claim 4, further comprising de-segmentation and de-compression units configured to de-segment and de-compress received packets to reconstruct network information.

6. A client device comprising:
a reception module configured to receive from an authentication server a connection message;
an analysis engine configured to analyze the received connection message;
a builder module configured to build network information based on the result of the analysis by the analysis engine of the received connection message;
a first sending module for sending build network information to an analysis server;
a reception module configured to receive procedural information from the analysis server in response to the sent network information; and
a second sending module for sending an authentication message to the authentication server wherein the authentication message is constructed based on the procedural information received from the analysis server.

7. The client device of claim 6, wherein the analysis engine comprises means for filtering the content of the connection message received, wherein the filtering means removes presentation and/or style information from the content of the connection message prior to building network information.
